(19) United States
(12) Patent Application Publication
(10) Pub. No.: US 2003/0041085 A1
(43) Pub. Date: Feb. 27, 2003

(54) Management system and method for network devices using information recordable medium

(76) Inventor: Kazuhiko Sato, Shinagawa (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/144,003

(22) Filed: May 10, 2002

(30) Foreign Application Priority Data
Aug. 23, 2001 (JP) 2001-253458

(51) Int. Cl. G06F 9/00

(52) U.S. Cl. 709/100

(57) ABSTRACT

There is provided a management system including a managed device connected to a network, and assigned network information that allows the managed device to communicate over the network, and a management device. The management device is connected to the network, and manages the managed device based on the network information and stores the network information in an information recordable medium. The management device has a drive unit which reads data from the information recordable medium, wherein the managed device is made accessible when the data read from the information recordable medium corresponds to the network information assigned to the managed device.

### BACKGROUND OF THE INVENTION

1. Field of the Invention

The present invention relates generally to management systems that manage a computer network, and more particularly to systems having drive units for reading network information from an information recordable medium.

2. Description of the Related Art

The present invention relates generally to management systems that manage a computer network. The present invention is suitable, for example, for apartment houses, and office buildings equipped with a computer network, such as a LAN (Local Area Network), so as to enhance the security of each terminal as well as the security of the entire network.

With the recent spread of LANs and WANs (Wide Area Networks), a large number of network devices, such as personal computers (“PCs” hereinafter), hubs, switches, and routers (hubs etc. are often called “agents”) can be connected to a network and its subnet(s) for frequent information sharing and communications. Distributed management can be adopted for a network's structure, performance, security, and billing, but such management systems may make it difficult and expensive to locate and deal with any fault in the network, and are not suitable for risk management. Therefore, centralized management of network statuses is in demand.

In order to realize centralized management of a network, a management device (also called “manager” or “server”) typically monitors connection statuses and agent traffic, after managed devices have been connected to the network and their communication parameters set up. The communication parameters may include an IP address, which allows the network devices to communicate with each other in the network, and the manager to manage the network devices.

However, in a network environment that is built with plural network devices, independent management of a specific network device has proven to be difficult. For example, in organizations which build a network with plural network devices to enable them to share printers, files, etc., some of the network devices for certain users, such as executives and administrators, often store confidential information. This information may include the company's trade secrets, employees' payment information, and employees' merit rating information, e.g., working hours and business result. Thus, an indiscretion problem may occur when these network devices are connected to the network.

These network devices storing confidential information might be protected, for example, when disconnected from the network for isolated use, however, such protection disadvantageously sacrifices benefits of a network connection such as to sharing printers and files, and can inconvenience users.

Special protection should be provided for these network devices in the network when they are connected to the network. Of course, if these network devices are made easily accessible to an unauthorized person, even the isolated use of them is insufficient to prevent indiscretion. One typical way of eliminating unauthorized accesses would be authentication of a user ID and password for such a device, but unauthorized persons can acquire that information with relative ease since a user problematically assigns his/her unforgettable name, birthday, telephone number etc. to the user ID and password.

Moreover, where companies maintain security for an office environment against intruders by relying upon a security company and/or by locking certain room(s), distributed management of the network and office environment would not be suitable for risk management.

### SUMMARY OF CERTAIN INVENTIVE EMBODIMENTS

A management system as one aspect of the present invention comprises a managed device, connected to a network and assigned network information that allows the managed device to communicate in the network, a management device, connected to the network and configured to manage the managed device based on the network information and to store the network information in an information recordable medium, and a drive unit configured to read the information recordable medium. The management system makes the managed device accessible to a user when the drive unit reads the network information stored on the information recordable medium, and when the network information read from the information recordable medium corresponds to the network information of the managed device. Therefore, this system does not allow a third party, who doesn't have an information recordable medium, to use the managed device, preventing the leakage of information through the managed device.

The information recordable medium is, for example, an IC card. The drive unit may include a storage part for storing the network information of the managed device, and a controller that stores in the storage part the network information read from the information recordable medium when determining that the network information is not stored in the storage part. The management system may store the network information in the storage part in the drive unit during the initial operation of the system. The drive unit may include a storage part for storing the network information of the managed device, and a controller which compares data read from the information recordable medium with the network information stored in the storage part, and makes the managed device accessible to a user in response to determining that the data read from the information recordable medium corresponds to the network information stored in the storage part. According to this management system, the managed device is made accessible to a user when the data read from the information recordable medium corresponds to (e.g., accords to or is included in) the network information stored in the storage part. Thus, the present invention does not require data stored in the information recordable medium to completely accord with the network information stored in the storage part, and the data may accord with part of the network information stored in the storage part.

The drive unit may communicate with the management device, wherein the management device may include a storage part for storing the network information of the managed device, and a controller which compares data sent from the drive unit with the network information stored in the storage part, and makes the managed device accessible to a user in response to determining that the data corresponds to the network information stored in the storage part. According to this management system, the drive unit communicates with the management device and the management device controls the accessibility of the managed device. The management system allows the management device to receive data read by the drive unit, and to determine whether the data read corresponds to the network information stored in the storage part, so as to control the accessibility of the managed device.

The management system may further comprise an interconnecting device which connects the network to the managed device and management device, wherein the management device configures the interconnecting device so as to assign a VLAN to the managed device based on the network information of the managed device. According to this management system, the management device configures the interconnecting device and logically divides the network based on the network information of the managed device, forming a plurality of groups which can not communicate with each other even in the same network. Thereby, the management device may maintain the security for each VLAN group in the network. The network information may include the VLAN (an identifier of the VLAN).

The interconnecting device may execute a predetermined operation when the drive unit reads predetermined data from the information recordable medium. The predetermined operation may include, for example, a collection of predetermined information and restriction of an access to the network. This trigger function of the interconnecting device can be advantageous to achieve an automatic process.

The management system may further comprise an admittance manager, connected to the management device, which controls admittance into an area in which the network is built, by reading the information recordable medium and communicating with the management device. This system may combine the entrance management to the area with the management by the management device, thereby achieving unitary management. The network may include a plurality of VLANs, and one of the VLANs may be assigned to the area. Thereby, the management device may maintain the security for each VLAN group in the network.

The network information may include a communication parameter necessary for the managed device to communicate in the network, e.g., an IP address, a subnet mask, a default gateway, a user ID and password, or a combination thereof, and device information that defines the managed device, e.g., a MAC address and/or a housing identifier.

A management system of another aspect of the invention comprises a managed device connected to a network and assigned network information that allows the managed device to communicate on the network, and a management device, connected to the network and configured to manage the managed device based on the network information. The managed device includes a first drive unit that reads the network information from an information recordable medium, and the management device includes a second drive unit for storing network information into the information recordable medium, and wherein the managed device is made accessible when the network information read by the first drive unit corresponds to the network information assigned to the managed device. This management system makes the managed device accessible when the first drive unit reads the network information from the information recordable medium. Therefore, this management system does not allow a third party having no information recordable medium to use the managed device, thereby preventing the leakage of information through the managed device.

According to another aspect of the invention, a method of managing access to a network through a managed device is provided, wherein the managed device is connected to the network and assigned network information that allows the managed device to communicate in the network. The method comprises reading data from an information recordable medium, storing the network information in a storage part, determining whether data read from the information recordable medium corresponds to the network information stored in the storage part, and making the managed device accessible to a user in the network in response to determining that the data read from the information recordable medium corresponds to the network information stored in the storage part. This management system makes the managed device accessible to a user when the data read from the information recordable medium corresponds to the network information stored in the storage part. Therefore, this system does not allow a third party having no information recordable medium to use the managed device, preventing the leakage of information through the managed device.

The method may further comprise configuring the network information in the managed device with data read from the information recordable medium. Thereby, this method manages both configuration and availability of the managed device for unitary management.

A network device according to still another aspect of the invention is connected to a network and assigned network information that allows the network device to communicate in the network includes a drive unit comprising a reader part for reading data from an information recordable medium, a storage part that stores the network information, and a controller that makes the network device accessible upon determining that data read by the reader part from the information recordable medium corresponds to the network information stored in the storage part. This network device may restrict its availability since it is available when the network information stored in the storage part is read from the information recordable medium. Thus, this network device prevents unauthorized use of the network and enhances the security of the network. The controller may configure the network information read by the reader part from the information recordable medium in response to determining that the network information has not yet been stored in the storage part. This initial operation may store the network information in the storage part and makes it usable for authentication. The drive unit controls power to be supplied to the network device, and the controller makes the network device accessible by allowing the power to be supplied to the network device. According to such a network device, the drive unit controls the power supply to the network device, restricting the availability of the network device.

A management device according to still another aspect of the present invention is connected to a network, manages a managed device connected to the network, and manages assigned network information that allows the management device to communicate on the network comprises a storage part which stores the network information, a drive unit which stores the network information into an information recordable medium to be used to configure the managed device, and a controller which controls access to the network device. This management device may store the network information in the information recordable medium, and manages both an operation and availability of the managed device, achieving unitary management.

According to another aspect of the present invention, a computer readable medium having a program for computer-executing a method of making accessible a managed device that is connected to a network and assigned network information that allows the managed device to communicate over the network, the network information being stored in an information recordable medium and a storage part, the method comprising determining whether data read from the information recordable medium corresponds to the network information that has been stored in a storage part, and making the managed device accessible in the network when the data read from the information recordable medium is determined to correspond to the network information stored in the storage part. This program also achieves the aforementioned operations.

Other objects and further features of the present invention will become readily apparent from the following description of preferred embodiments with reference to accompanying drawings.

### BRIEF DESCRIPTION OF THE DRAWINGS

FIG. 1 is a structural view of one embodiment of a management system of the present invention.

FIG. 2 is a structural view of one embodiment of a network built in the management system shown in FIG. 1.

FIG. 3 is a block diagram of one embodiment of a management device as shown in FIG. 1.

FIG. 4 is a view showing an example of management table, which would be stored in the memory of the management device shown in FIG. 3.

FIG. 5 is a block diagram of one embodiment of an entrance server as shown in FIG. 1.

FIG. 6 is a block diagram of one embodiment of an interconnecting device as shown in FIG. 1.

FIG. 7 is a block diagram of one embodiment of a network device as shown in FIG. 1.

FIG. 8 is a block diagram of one embodiment of an admittance manager as shown in FIG. 1.

FIG. 9 is a flowchart for explaining an initial operation of the management system shown in FIG. 1.

FIG. 10 is a flowchart of one embodiment of a management-table creating program for creating the table shown in FIG. 4.

FIG. 11 is a timing chart for explaining an operation of the management system shown in FIG. 1.

FIG. 12 is a flowchart showing a control operation of an IC card drive shown in FIG. 7.

FIG. 13 is a flowchart showing a control method by the admittance manager shown in FIG. 8.

FIG. 14 is a flowchart showing a control method by a management device shown in FIG. 3.

### DETAILED DESCRIPTION OF CERTAIN EMBODIMENTS

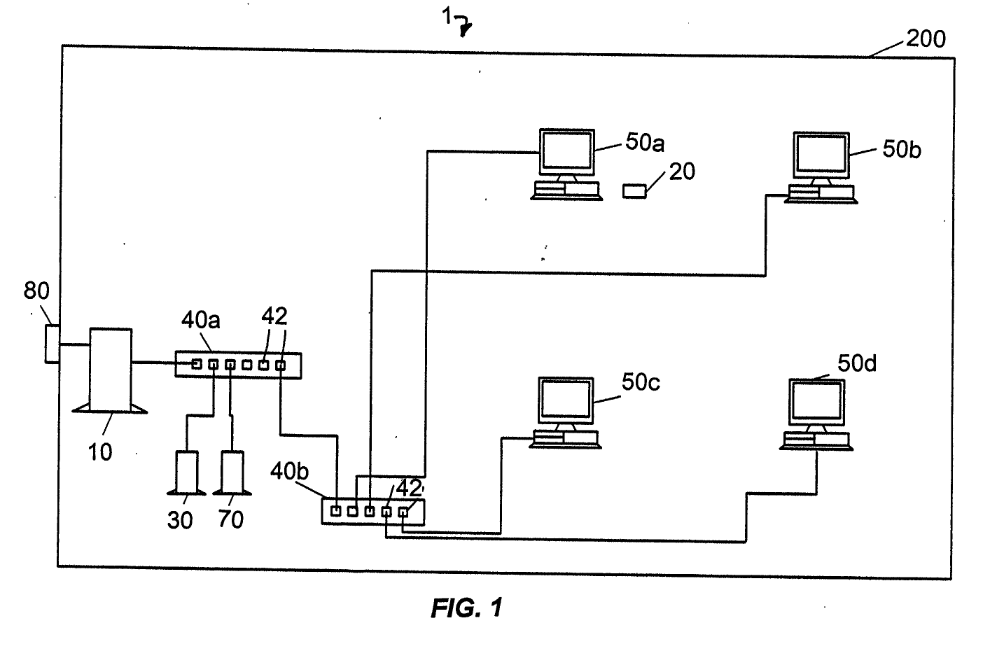

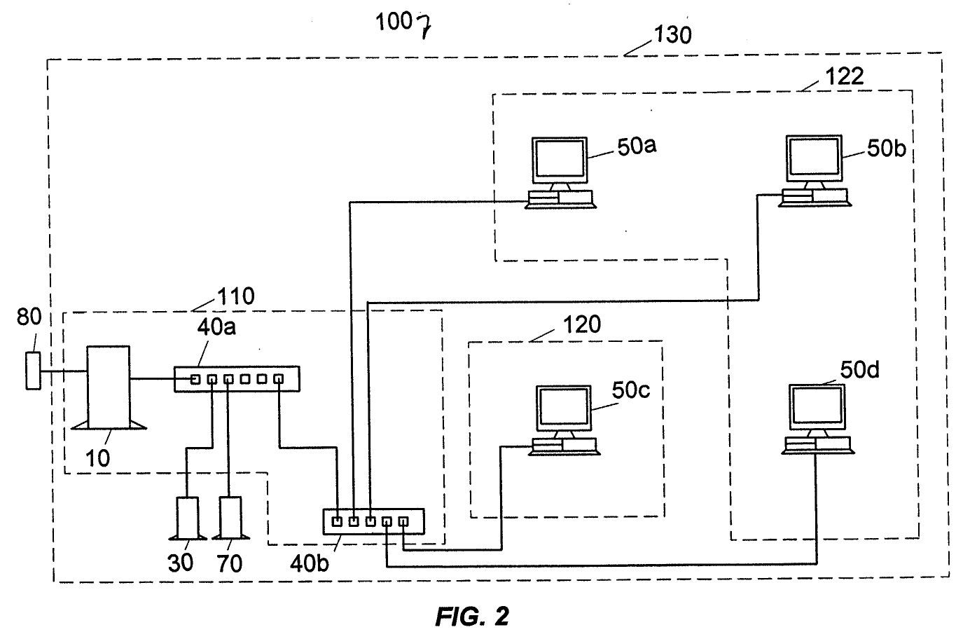

A description will now be given of a management system 1 of the present invention with reference to the accompanied drawings. Here, FIG. 1 is a structural illustration of the management system 1 of the present invention. FIG. 2 is a structural illustration of the network 100 built in the management system 1. The management system 1 includes a management device 10, an entrance server 30, interconnecting devices 40, network devices 50, a common server 70, and an admittance manager 80. In this disclosure, interconnecting devices 40 and network devices 50 respectively generalize interconnecting devices 40a and 40b and network devices 50a-50d, unless otherwise specified.

The management system 1 can be applied to an office 200 in a company, organization, etc. The network 100, built in the office 200, includes the interconnecting devices 40 to which a plurality of network devices 50 are connected. The network devices 50a-50d are connected to the interconnecting device 40b, while the interconnecting device 40b is connected to the interconnecting device 40a. The management device 10, entrance server 30, and common server 70 are also connected to the interconnecting device 40a. The admittance manager 80 is connected to the management device 10 and is provided at an entrance (not shown) to the office 200.

The management device 10 manages the network devices 50. More specifically, the management device 10 configures the interconnecting devices 40 such that a different VLAN (Virtual Local Area Network) is assigned to each or some of the network devices 50 based on the device identifier of the network device 50. Moreover, the management device 10 manages entrance to and exit from the office 200. The management device 10 can also manage connection status and traffic of each network device 50 through the interconnecting devices 40. For example, the network device 10 can obtain from the interconnecting device 40 the amount of communication and/or communication time for each communication port 42 in the interconnecting device 40. The management device 10 may control communications of the communication port 42 based on the obtained communication amount and/or communication time.

The management device 10 in this embodiment can be implemented as a desktop PC, including an integrated circuit (IC) card drive 17 externally or internally. A contact-type IC card 20 can be used with the IC card drive 17, and the non-contact-type IC card is not excluded from the present invention. Further, the present invention is broadly applicable to information recordable media in addition to the IC card, wherein the IC card may be a smart card.

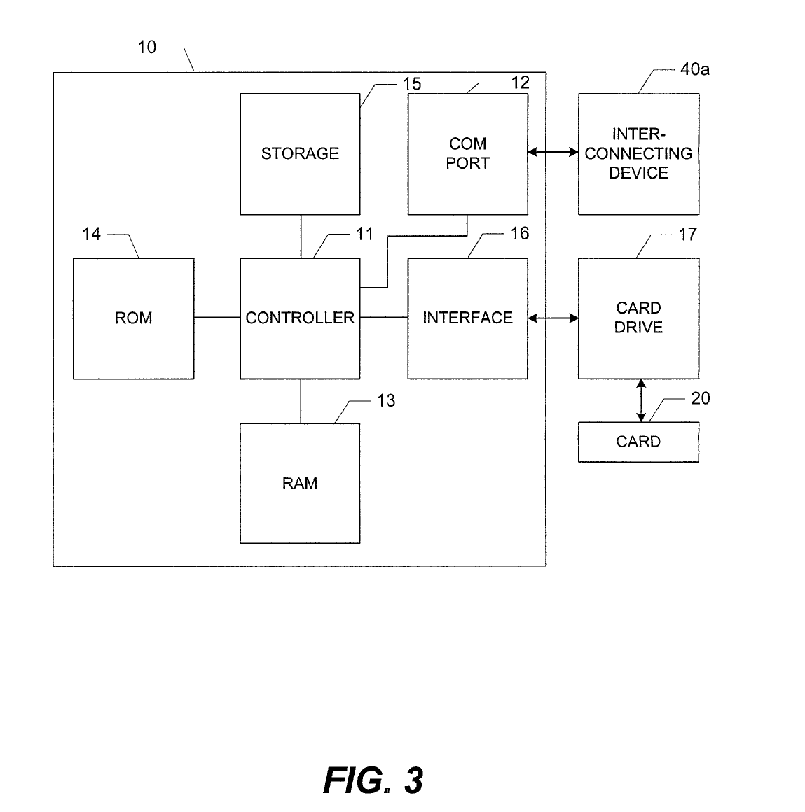

FIG. 3 is a schematic block diagram of the management device 10. The management device 10 includes, as shown in FIG. 3, a controller 11, a communication port 12, a RAM (Random Access Memory) 13, a ROM (Read Only Memory) 14, a storage part 15, an interface 16, and an IC card drive 17. FIG. 3 does not show input/output devices (e.g., a keyboard, a mouse or other pointing devices, and an indication device, such as a display) provided with the management device 10. However, using an input/output device, an operator of the management device 10 may control the IC card drive 17, enter various kinds of data in the storage part 15, and download software into the RAM 13, ROM 14 or storage part 15.

The controller 11 can be a processor such as a central processing unit (CPU), or a microprocessor (MPU), and can control each module in the management device 10. If necessary, the management device 10 may be connected to a host (not shown), and the controller 11 may communicate with the host.

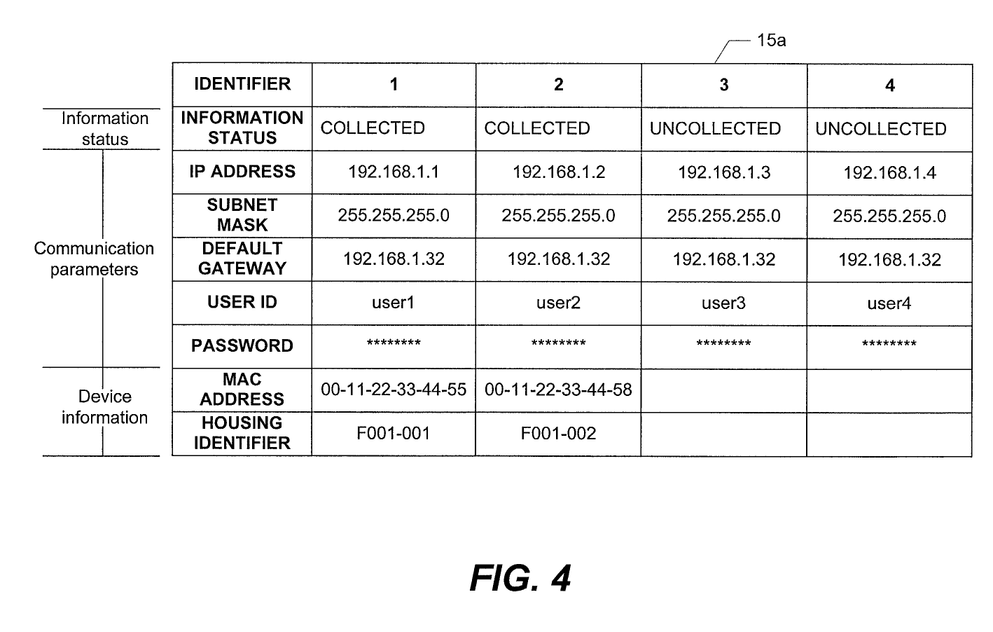

The controller 11 executes a management-table creation program stored in the storage part 15, sets communication parameters for the network devices 50, and creates a management table 15a, shown in FIG. 4. The controller 11 can store part of the management table 15a in a number of IC cards 20 via the IC card drive 17.

The controller 11 sets up the interconnecting devices 40 via the communication port 12 so as to assign different VLANs based on device identifiers, specifically including MAC (Media Access Control) addresses of network devices 50, in the management table 15a. The present invention does not require the controller 11 to set up the interconnecting device 40 and assign a different VLAN to each network device 50 in the network 100. In other words, the same VLAN may include more than one network device 50. Importantly, according to the present embodiment, a different VLAN can be assigned to specific network device(s) 50 (e.g., for executives and accountants) and other network devices.

Referring back to FIG. 2, the controller 11, in one embodiment, assigns a VLAN 110, which is the same as that of the management device 10, to the interconnecting devices 40. Therefore, the management device 10 may control the interconnecting devices 40 in the VLAN 110, and performs the VLAN configuration for the interconnecting devices 40. The controller 11 assigns VLANs 120 and 122, different from the VLAN 110, to the network device 50c and the plural network devices 50a, 50b and 50d, respectively. As a result, the management device 10 cannot access files in the network devices 50. Conversely, the network devices 50 can neither access files in the network device 10, nor perform VLAN configuration for the interconnecting devices 40.

The network device 50c is independent of and cannot share files with the network devices 50a, 50b and 50d. These network devices 50a, 50b and 50d may share files in the same VLAN 122, but cannot access files in the network device 50c, which is in the VLAN 120. The controller 11 assigns a VLAN 130, which allows communications with the VLANs 110, 120 and 122, to the entrance and common servers 30 and 70. Thus, the entrance and common servers 30 and 70 may communicate with the VLANs 110, 120 and 122, and the network device 50c may use the common server 70. An identifier of the VLAN may be included in the management table 15a, which will be described later.

Referring again to FIG. 3, the communication port 12 may be an LAN adapter connected to the interconnecting devices 40, a USB port or IEEE 1394 port for providing connections to the Internet (as necessary, via an Internet Service Provider (ISP)) via a modem, or a terminal adapter (TA) through the public telephone network, ISDN, or various types of dedicated lines.

The RAM 13 can temporarily store data to be read from the ROM 14 and storage part 15, data to be written in the storage part 15, and the like. The ROM 14 can store various kinds of software and firmware for operation of the controller 11, and other types of software.

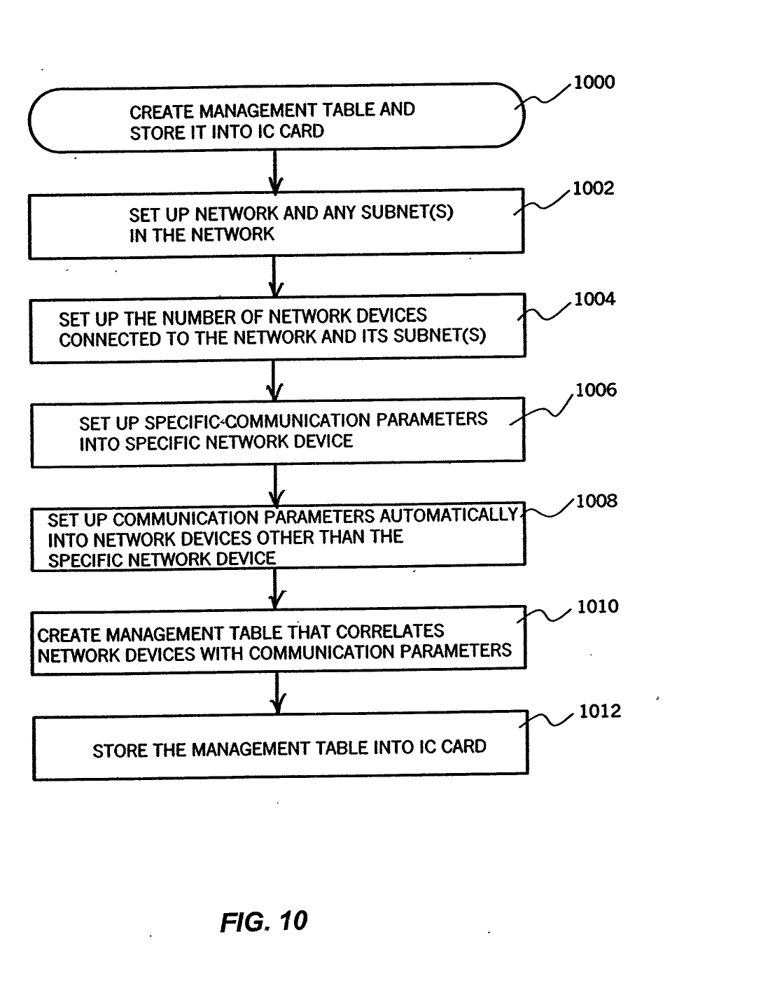

The storage part 15 stores the management-table creation program for creating the management table 15a shown in FIG. 10 as well as the management table 15a shown in FIG. 4. FIG. 4 shows one example of the management table 15a. The management-table creation program may also be distributed as an independent commodity. Accordingly, the program may be stored in a CD-ROM or other commercial recordable media, or distributed and updated online via a network, such as the Internet.

The management table 15a in the present embodiment indicates a relationship between the communication parameters corresponding to the network devices 50 and the device information unique to the network devices 50, where four network devices 50 are connected to the network 100 or its subnet(s) as a segment of the network 100. This management table 15a enables a unitary inventory management of the communication parameters and device information for the plurality of network devices 50.

A number of identifiers, numbered 1-4, identify four different network devices 50. The information statuses are indicated by “collected” and “uncollected.” The “collected” indicator denotes that device information, as will be described later, has been stored, while “uncollected” denotes that the device information has not been stored yet. As shown in FIG. 4, the network devices 50 labeled with identifiers numbered 1 and 2 have stored the device information. The “collected” information can also be stored in the IC card 20 that will be described later.

The communication parameters in the table 15a include, but are not limited to, an IP (Internet Protocol) address, a subnet mask, a default gateway, and a user ID and password. The communication parameters may further include a DNS (Domain Name System) address and a router address.

The IP address is a period separated four-block address, each block ranging 0-255 in decimal notation, and assigned to a computer connected to the TCP/IP (Transmission Control Protocol/Internet Protocol) network circumstance. The IP address is included in an IP header provided by the IP protocol in the network layer in the TCP/IP protocol.

The subnet mask is a bit pattern for separating the host address part of the IP address into a subnet address and a host address. When “255.255.255.0” is defined by the subnet mask, the first three numbers are represented in binary notation as “11111111”. A “1” denotes the same network in the subnet mask. Accordingly, it is to be understood that the four network apparatuses 50 are connected to the network “192.168.1.0” in the present embodiment.

The default gateway is an IP gateway through which a host transmits an IP datagram, except when the host for transmitting the IP datagram incorporates a routing table including a destination IP address and when the destination IP address has the same network address as the transmitting host.

The user ID and password pair is an identifier for identifying a user of the network 50 when the user attempts to login the network. It can be advantageous for the management device 10 to acquire this information offline from a user of each network device 50 before the management device 10 sets up the communication parameters for the network device 50.

The communication parameters may also include cryptographic information (e.g., key information and encryption scheme), and an address of the management device 10 for transmitting a notice that the network device 50 is abnormal.

The device information unique to the network device 50 may include a MAC address, a housing identifier, a hardware version, and a firmware version.

The MAC address is an address for identifying an information device connected to a LAN and assigned to a NIC (Network Interface Card) in each computer. The MAC address is a physical address defined in a data link layer, which is the second layer in an OSI (Open System Interconnection) reference model, and can serve as a unique identifier. The housing identifier is an identifier for a housing of the network device 50, and can be, for example, a lot number given by a manufacturer of the network device 50, which can also serve as a unique identifier.

The interface 16 can be, for example, a USB port or a parallel port, and connects the management device 10 to an external device, e.g., the IC card drive 17 in this embodiment. The interface includes any interface irrespective of a type of data transmission method, such as parallel and serial systems, and a connection medium, such as a radio or wire transmission.

In operation, the IC card drive 17 writes data onto and reads data from the IC card 20. The IC card drive 17 writes a management table 15a, which has been output by the controller 11 through the interface 16, onto the IC card 20 in this embodiment. As described above, the information recordable medium applicable to the present invention is not limited to use of an IC card. Therefore, an appropriate drive may be selected depending upon a type of the information recordable medium, wherein when the IC card is a smart card the IC card drive may be a smart card drive. The IC card drive 17 may use any technology known in the art or be manufactured by those skilled in the art, and a detailed description thereof is therefore omitted.

The IC card 20, in this embodiment, serves as an admittance card (authentication card) to the office 200, as well as a card for authorized use with and initial setup for the network devices 50. Therefore, in one embodiment of the invention a MAC address of network device 50 which a user attempts to use must be identical to a corresponding MAC address in the management table 15a stored in the IC card 20. Thereby, only the IC card 20 that stores a MAC address of a particular network device 50 can allow use of that network device 50. (In one embodiment, the network device 50 is not supplied power unless the IC card drive 60 authenticates the corresponding MAC address in the management system 1.) Although this embodiment uses a MAC address as an example of the network information, part or all pieces of other network information including device information, such as a housing identifier, one or more communication parameters, such as an IP address, and a VLAN may be used.

The IC card 20 may express stored office information by its external appearance. For example, the IC card 20 may display a different letter, design, and color and combination thereof for each company department, directly (for example, by embossing it on the housing of the IC card 20) or indirectly (for example, by labeling it onto the IC card 20).

The IC card 20 generalizes a smart card, an intelligent card, a chip-in card, a microcircuit (or microcomputer) card, a storage part card, a super card, a multifunctional card, a combination card, etc. The IC card of the present invention is not limited to a card-shape medium, but may include any shape, such as a stamp size and smaller ultra-micro and coin shapes.

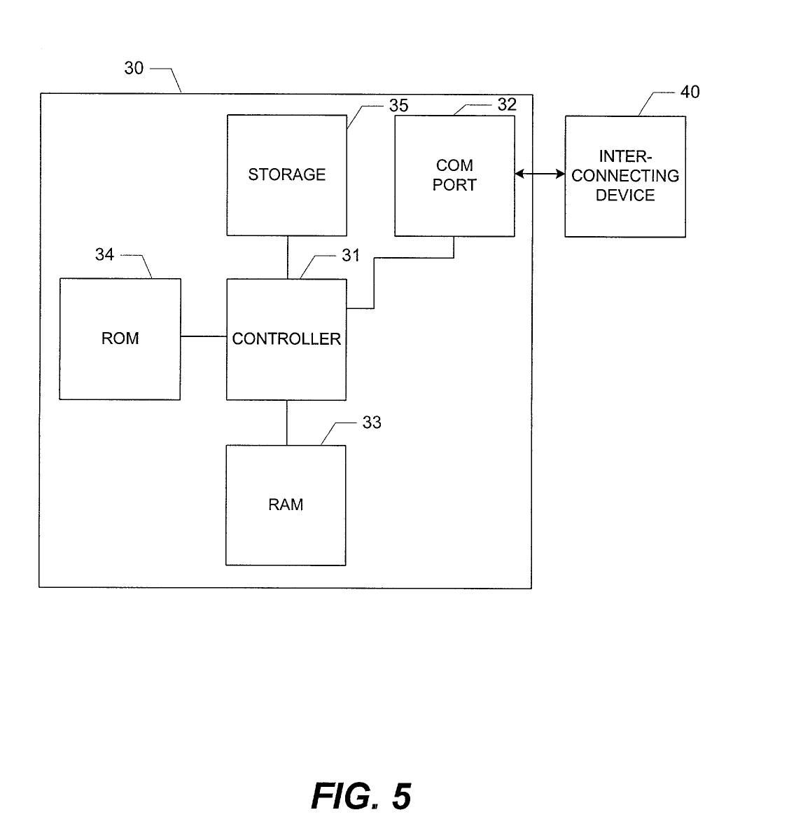

FIG. 5 is a block diagram of the entrance server 30. The entrance server 30 permits a logon to the network by the network device 50 having a predetermined MAC address. As shown in FIG. 5, the entrance server 30 includes a controller 31, a communication port 32, a RAM 33, a ROM 34, and a storage part 35.

The controller 31 refers to the management table 15a stored in the management device 10, and permits a logon to the network by the network device 50 having a predetermined MAC address.

The communication port 32 may be an LAN adapter connected to the interconnecting devices 40, a USB port or IEEE 1394 port for providing connections to the Internet (as necessary, via an Internet Service Provider (ISP)) via a modem, or a terminal adapter (TA) through the public telephone network, ISDN, or various types of dedicated lines.

The RAM 33 temporarily stores data to be read from the ROM 34 and storage part 35, data to be written in the storage part 35, and the like. The ROM 34 can store various kinds of software and firmware for operation of the controller 31, and other types of software.

The storage part 35 stores a program for authenticating MAC addresses, which will be described in the operation later. The authenticating program is a program to permit a login to the network 100 by the network device 50.

The interconnecting device 40 connects each network device 50 to the network 100, and includes one or more interconnecting ports 42 for connection to the network device(s) 50. The interconnecting device 40 may be, for example, a hub, a switch, a router, any other concentrator, a repeater, a bridge, a gateway, a PC device, or a wireless interconnecting device (e.g., an access point as a interconnecting device for wireless LAN). The interconnecting device 40 may have a trigger function to execute a predetermined operation, such as a collection of predetermined information and restriction of an access to the network. This trigger function may be coupled with data read from the IC card 20 by the IC card drives 17 and 60, and/or IC card reader 86. This trigger function of the interconnecting device 40 can be advantageous to achieve an automated process.

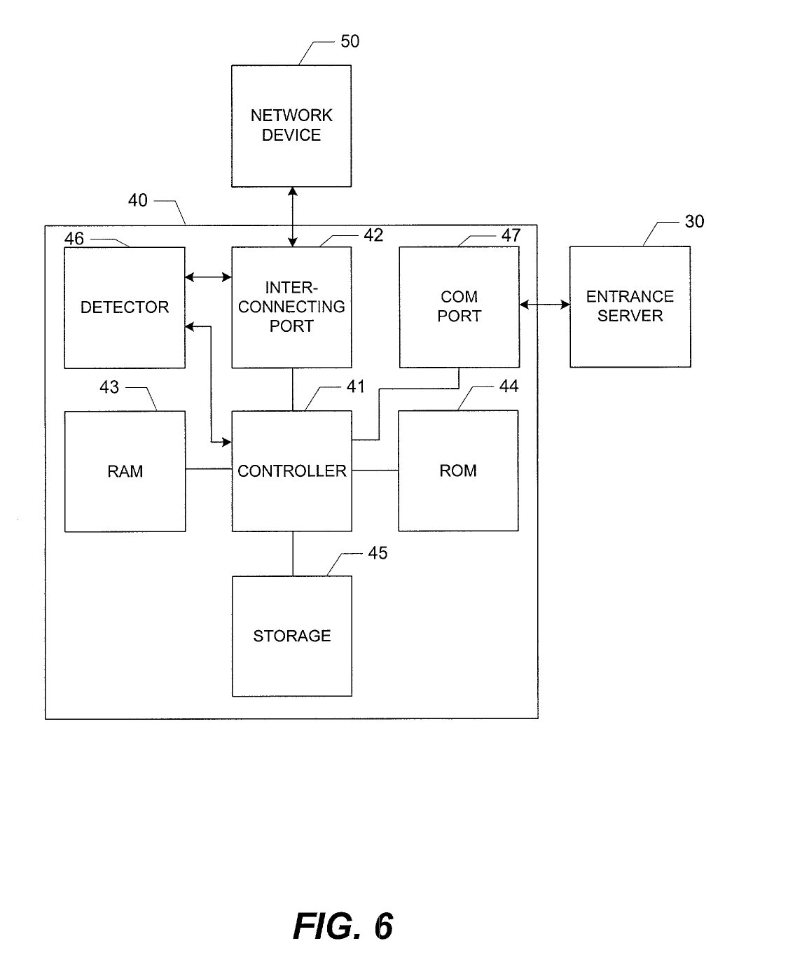

FIG. 6 is a block diagram of the interconnecting device 40. The interconnecting device 40 includes, as shown in FIG. 6, a controller 41, an interconnecting port 42, a RAM 43, a ROM 44, a storage part 45, a detector 46, and a communication port 47. Again, in FIG. 6, an input/output device is not illustrated for simplicity purposes. Through the input/output device, an operator of the interconnecting device 40 may input various kinds of data in the storage part 45, and download software into the RAM 43, and ROM 44 and storage part 45.

The controller 41 can be a processor such as a CPU or an MPU, and can control each module in the interconnecting device 40. The controller 41 communicates with the detector 46 to provide the entrance server 30 with information for identifying the network device 50, and manages the interconnecting ports 42 such that each or some of the network devices 50 to be connected to the interconnecting device 40 may be assigned a different VLAN, based on a MAC address of the network device 50, in response to a request from the management device 10.

The interconnecting port 42 is a communication port to which each network device 50 can be connected by a cable. More specifically, one of the interconnecting ports in the network device 40a can be connected to the network device 40b. In the present embodiment, the network devices 50a-50d are connected to the interconnecting ports in the network device 40b.

The RAM 43 can temporarily store data to be read from the ROM 44 and storage part 45, data to be written in the storage part 45, and the like. The ROM 44 serves to store various kinds of software and firmware for operations of the controller 41, and other types of software. The storage part 45 stores a program for managing the interconnecting ports 42.

The detector 46 can detect power-on of the network device 50 by communicating with the interconnecting port 42, and notify the controller 41 of the detection. Since the detector 46 compares the voltage of the interconnecting port 42 with a specific slice level for detection, and can use any structure known in the art, a detailed description of the detector 46 is therefore omitted.

The communication port 47 may be an LAN adapter connected to the interconnecting devices 40, a USB port or IEEE 1394 port for providing connections to the Internet (as necessary, via an Internet Service Provider (ISP)) via a modem, or a terminal adapter (TA) through the public telephone network, ISDN, or various types of dedicated lines. The interconnecting device 40 communicates with the management device 10 through the communication port 47.

The network device 50 is a device managed by the management device 10, and can be a network device, such as a hub, a switch, a router, any other concentrator, a repeater, a bridge, a gateway device, a PC, a server, a wireless interconnecting device (e.g., an access point as a interconnecting device for wireless LAN), or a game machine having a communication function.

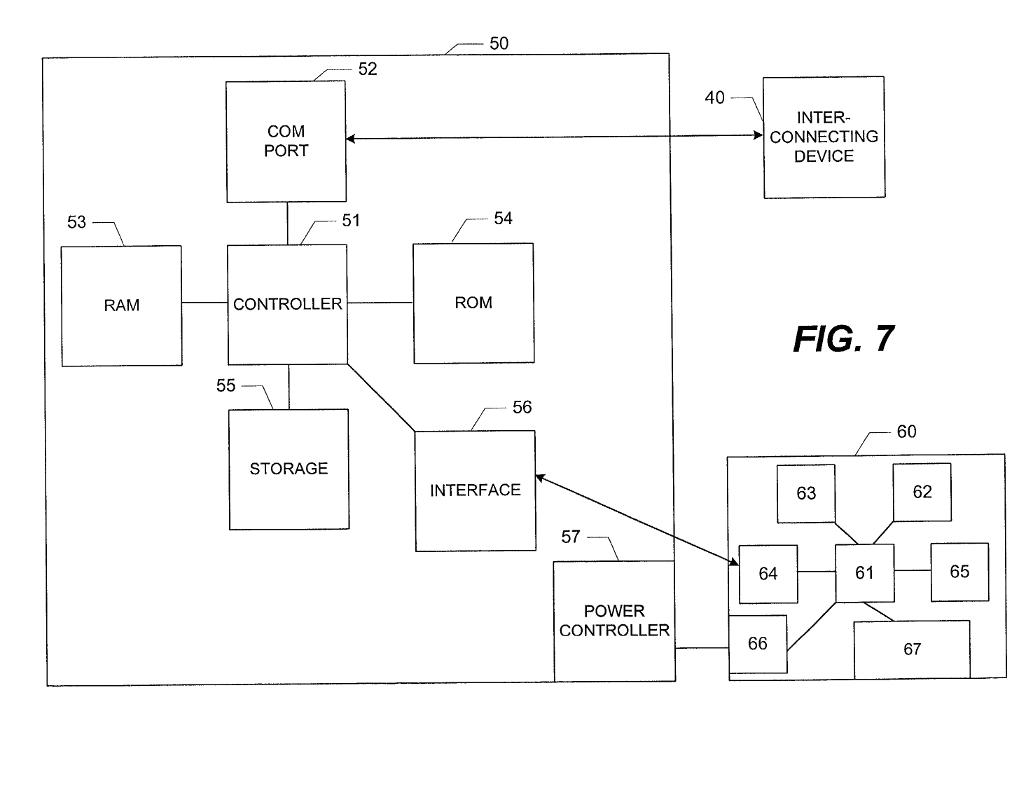

FIG. 7 is a block diagram of the network device 50. The network device 50 includes, as shown in FIG. 7, a controller 51, a communication port 52, a RAM 53, a ROM 54, a storage part 55, an interface 56, a power controller 57, and an IC card drive 60. In FIG. 7 as well, the input/output devices provided with the network device 50 are omitted for simplicity purposes. Through the input/output device, an operator of the network device 50 may input various kinds of data in the storage part 55, and download software into the RAM 53, and ROM 54 and storage part 55. The IC card drive 60 may be internal or external to the network device 50.

In this embodiment, the power to drive the network device 50 is supplied to the IC card drive 60 such that the power supply to the network device 50 is controlled by the IC card drive 60 and selectively supplied to the network device 50. For example, the network device 50 can include a power circuit that is structured to drive only the IC card drive 60, and another power circuit can be structured to drive only the network device 50 and not the IC card drive 60, wherein each circuit is supplied power independently. It can be advantageous for the IC card drive 60 to control the power circuit for driving only the network device 50. Where only one power circuit drives the network device 50, it supplies power to the IC card drive 60, and the IC card drive 60 controls the power supply so that the network device 50 can share the power supply. The instant embodiment adopts the former type, but may employ the latter type.

The controller 51 can be a processor such as a CPU or an MPU, and can control each module in the network device 50. The controller 51 reads communication parameters stored in an IC card 20 through the IC card drive 60, and performs the initial setup based on this information. Moreover, The controller 61 stores the device information on the IC card 20 via the IC card drive 60.

The communication port 52 may be an LAN adapter for establishing a connection to the network, a USB port or IEEE 1394 port for providing connection to the Internet (as necessary, via an Internet Service Provider (ISP)) via a modem, or a terminal adapter (TA) through the public telephone network, ISDN, or various types of dedicated lines.

The RAM 53 can temporarily store data to be read from the ROM 54 and storage part 55, data to be written in the storage part 55, and the like. The ROM 54 can store various kinds of software and firmware for operation of the controller 51, and other types of software. The storage part 55 can store a communication parameter and a configuration program. The configuration program receives the communication parameters from the management device 10 and configures them in the network device 50.

The interface 56 can be, for example, a USB or parallel port, and connects the management device 10 to an external device, e.g., the IC card drive 60 in this embodiment. The interface includes can be an interface irrespective of a type of data transmission method, such as parallel and serial systems, and a type a connection medium, such as a radio or wire transmission.

The power controller 57 controls the power supply for driving the network device 50 and not the IC card drive 60. The power controller 57 can be, for example, a switch and the like, and may supply and stop supplying power to the network device 50 based on a signal sent from the IC card drive 60. The power controller 57 is connected to a power-supply cable, through which the power is supplied from the power controller 57.

The IC card drive 60 reads information stored in the IC card 20, and writes information onto the IC card 20. The IC card drive 60, in this embodiment, includes a controller 61, a RAM 62, a ROM 63, an Interface 64, a storage part 65, a signal transmitter 66, a recorder/reproducer 67, and a sensor (not shown).

The IC card drive 60 includes an IC-card insertion opening (not shown), and the recorder/reproducer 67 may read the IC card 20 when the IC card 20 is inserted into the IC card drive 60 through the insertion opening. An eject button (not shown) can be provided near the insertion opening to eject the inserted IC card, and may use any technology to achieve this function. For example, the eject button can be structured to be spring-loaded, whereby the spring force ejects the IC card from the insertion opening when the eject button is pressed.

The controller 61 can be a processor such as a CPU or an MPU, and can control each module in the IC card drive 60. The controller 61, in conjunction with the present invention, compares, for authentication purposes, the MAC address stored in the storage part 65 with the MAC address in the management table 15a in the IC card 20. As described later, the controller 61 can notify the controller 51 for the initial setup, as will be discussed later, that the IC card 20 stores the communication parameters but no MAC address. Thus, the IC card 20 that stores no MAC address is used to initially set up the network device 50, while the security to access the network device 50 is maintained against an unauthorized user who attempts to perform the initial setup.

The RAM 62 can temporarily store data to be read from the ROM 63 and storage part 65, data to be written in the storage part 65, and the like. The ROM 63 can store various kinds of software and firmware for operation of the controller 61, and other types of software. The interface 64 connects electrically with the interface 56 of the network device 50, transmits information read by the recorder/reproducer 67 to the controller 51, and records information from the controller 51. The storage part 65 can store the MAC address of the network device 50. Alternatively, the MAC address may be stored in the ROM 63.

The signal transmitter 66 is a module to be electrically connected to the power controller 57, and sends a signal from the controller 61 that manages the power controller 57. The recorder/reproducer 67 contacts the IC card 20, reads information from, and writes information onto the IC card 20. The sensor (not shown) determines whether the IC card 20 has been inserted into the insertion opening. For example, the sensor can be an optical sensor including, for example, light-emitting and light-receiving elements. According to a thus-structured sensor, the IC card 20 when inserted, for example, interrupts a beam emitted from the light-emitting element which is to be incident on the light-receiving element, turning the sensor signal OFF, while the IC card 20 when ejected enables the beam from the light-emitting element to enter the light-receiving element, turning the sensor signal ON. Thus, the controller 61 recognizes the presence of the IC card 20 by checking the ON and OFF states in the signal output from the sensor.

Referring back to FIGS. 1 and 2, the common server 70 can be a server that is shared in the office 200, and may be, for example, a file server, a print server, an application server, a proxy server, a mail server, etc. Those skilled in the art can conceive such a common server, and a description is therefore omitted.

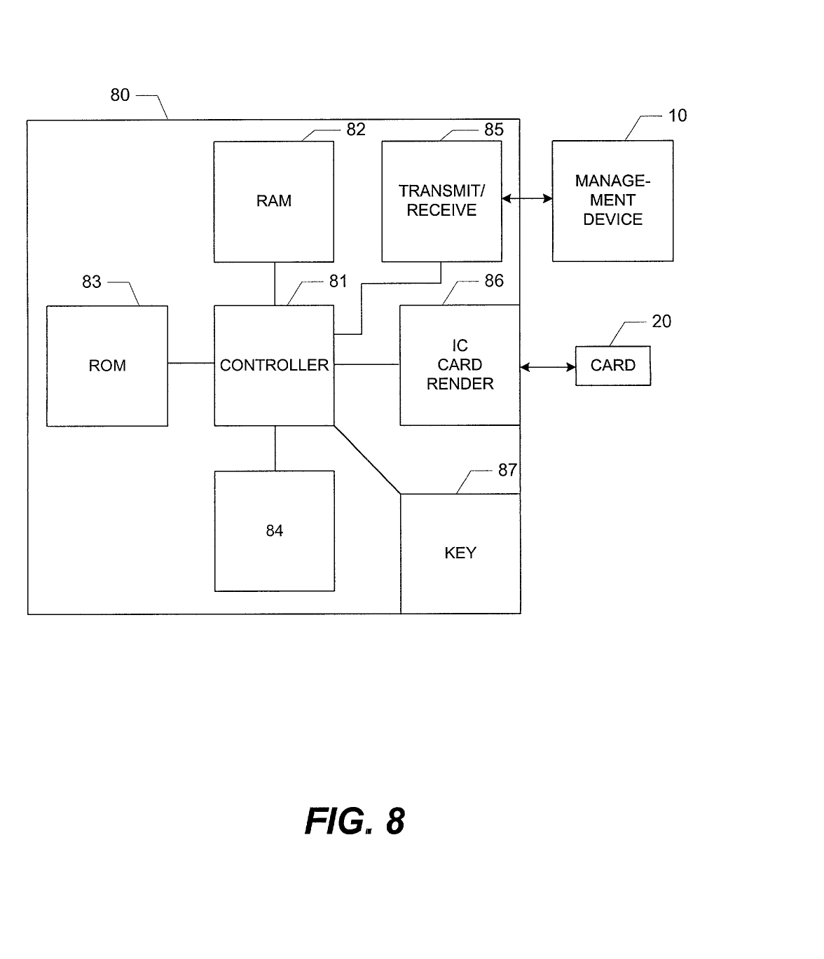

FIG. 8 is a block diagram of the admittance manager 80. The admittance manager 80 manages user's admittance to and exit from the office 200, and includes, as shown in FIG. 8, a controller 81, a RAM 82, a ROM 83, a storage part 84, a transmitter/receiver 85, an IC card reader 86, and a key 87.

The controller 81 can be a processor such as a CPU or an MPU, and can control each module in the admittance manager 80. The controller 81 executes an admittance management program, which will be discussed in the operation in detail, and manages user's admittance to the office 200. More specifically, the controller 81 sends to the management device 10 a MAC address stored in the IC card 20 and read by the IC card reader 86. The controller 81 locks and unlocks the key 87 in accordance with the authentication result from the management device 10.

The RAM 82 can temporarily store data to be read from the ROM 83 and storage part 84, data to be written in the storage part 84, and the like. The ROM 83 can store various kinds of software and firmware for operation of the controller 81, and other types of software. The transmitter/receiver 85 can connect with the management device 10 electrically (or using a radio communication system), transmits, and receives signals between the management device 10 and the controller 81. The IC card reader 86 reads information stored in the IC card 20 and sends the information to the controller 81 through an interface (not shown). The IC card reader 86 can be any technology known in the art. The key 87 can be a key at an entrance, such as a door (not shown), in the office 200, which electrically locks and unlocks the entrance as a result of communications with the controller 81. The key 87 may use, for example, technology known as an electronic key.

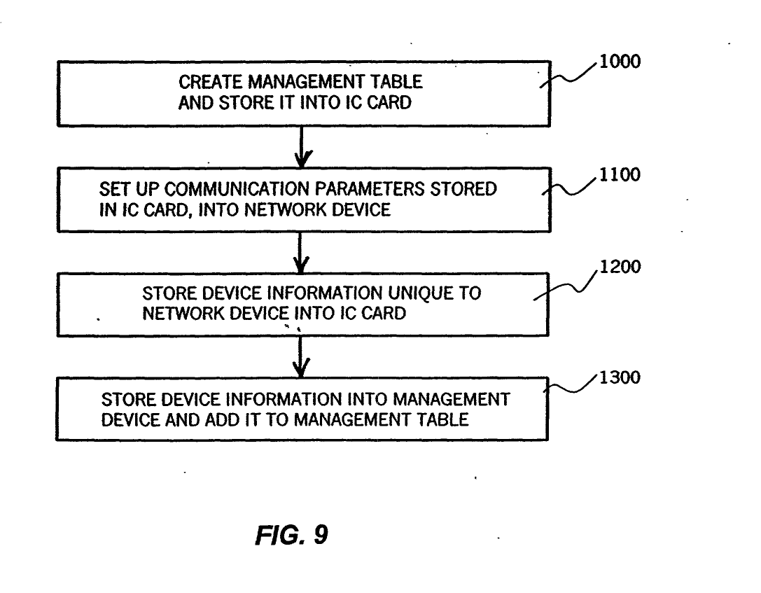

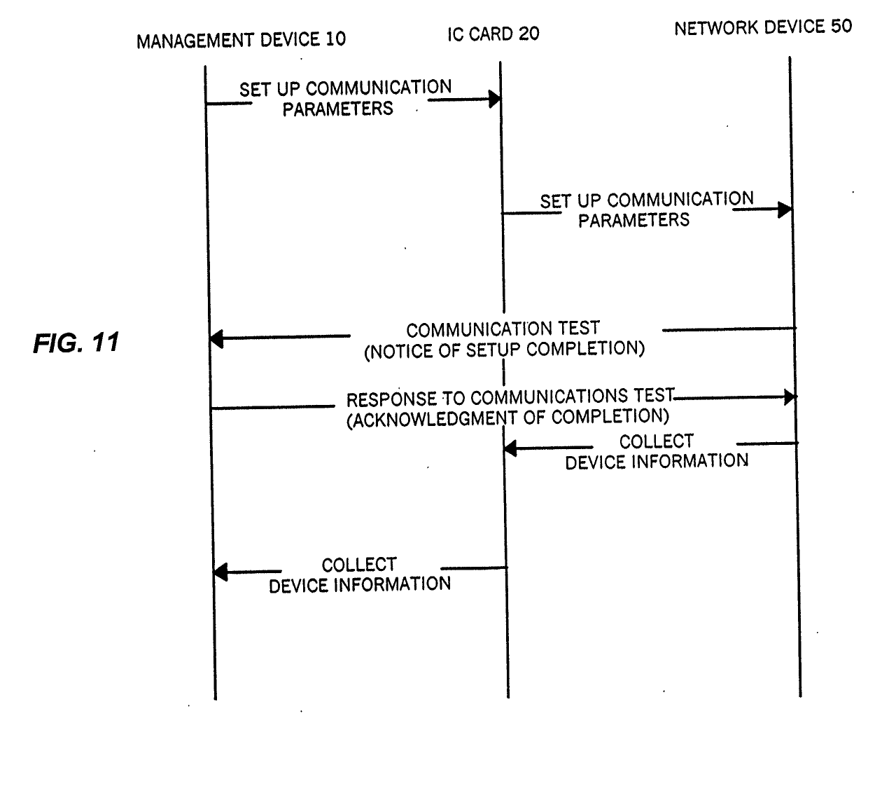

A description will now be given of an operation of the management system 1. First, a description will be given of the configuration operation of the communication parameters with reference to FIGS. 9-11. Here, FIG. 9 is a flowchart for explaining the operation of the management system 1. FIG. 10 is a flowchart of a management-table creation program. FIG. 11 is a timing chart for explaining the operation of the management system 1.

Referring to FIG. 9, the management system 1 creates the management table 15a, and stores the management table 15a into the IC card 20 in a step 1000. The step 1000 is illustrated as an arrow from the management device 10 to the IC card 20 in FIG. 11.

A detailed description will now be given of the step 1000 with reference to FIG. 10. The management device 10 can store the management table 15a in the storage part 15, but does not have to create the management table 15a by itself and may store the management table 15a created by another PC or the like. Therefore, although the management device 10 performs such a step in this embodiment, another PC or the like may exercise the method illustrated in FIG. 10.

The controller 11 prompts an administrator of the network 100 to enter the network 100 and any subnet(s) in the network 100, and configures them in accordance with the entry, in a step 1002. The administrator may set up, for example, a subnet for each department.

The controller 11 then prompts the administrator to enter the number of network devices 50 to be connected to the network 100 and its subnet(s), and sets up the number upon entry in a step 1004.

The controller 11 then sets a specific communication parameter for each specific network device 50 in a step 1006. That is, as in a step 1008, which will be described below, the controller 11 automatically sets up communication parameters for the network devices 50, but leaves a freedom to select a preferred IP address for a particular network device 50. This, for example, allows a user who uses a specific network device 50 (e.g., a manager of the department) to select the lowest IP address.

The controller 11 then automatically sets up communication parameters for the network devices 50 other than the specific network device 50 in step 1008. In step 1008, the controller 11 may set up the IP addresses in consecutive numbers or at random. This step reduces the burden on the administrator during the configuration in comparison with the conventional manual configuration method, which uses serial communications to set up IP addresses in the network devices 50.

The controller 11 then creates the management table 15a that correlates the network devices 50 with their communication parameters in a step 1010. As a result, the management table 15a, shown in FIG. 4, is prepared. Th step 1010, as described above, allows the administrator of the management device 10 to unitarily administer the network 100.

Lastly, the controller 11 can extract and stores part of the management table 15a in corresponding IC card(s) 20 through the IC card drive 17 in a step 1012. More specifically, the controller 11 commands the IC card drive 20 via the interface 16 to extract one of the communication parameters in the management table 15a from the storage part 15, and store it in the IC card 20. The controller 11 may extract the part of the management table 15a in the order from the smallest identifier or at random, or indicate a message that requests the administrator to select the specific part of the management table 15a to store.

The IC card 20 may have internal information for identifying the stored information. For instance, a department and its location may be recorded as property information of the management table 15a together with the management table 15a.

If the management device 10 has already been given a user ID/password pair, used for a user of the network device 50 to log in the network 100, the controller 11 adds this pair to the management table 15a. Otherwise, the controller 11 will add this pair later.

Referring back to FIG. 9, the communication parameters in the IC card 20 are set on the network device 50 in a step 1100. The step 1100 is indicated as an arrow from the IC card 20 to the network device 50 in FIG. 11.

The administrator of the management device 10 ejects the IC card 20 from the IC card drive 17, and carries and inserts it into the IC card drive 60 at the network device 50. Because the administrator of the management device 10 physically transports the IC card 20 to the network device 50, network security can be more effectively maintained, since he/she would not use the IC card 20 at a terminal for unauthorized accesses.

Even though anyone other than the administrator of the management device 10 can carry the IC card 20, the security of the card 20 can be enhanced in comparison with an initial set up by the conventional method, such as a DHCP (Dynamic Host Configuration Protocol). The network device 50 should include, internally or externally, an IC card drive 60, and thus those network devices which are not equipped with an IC card drive may be eliminated.

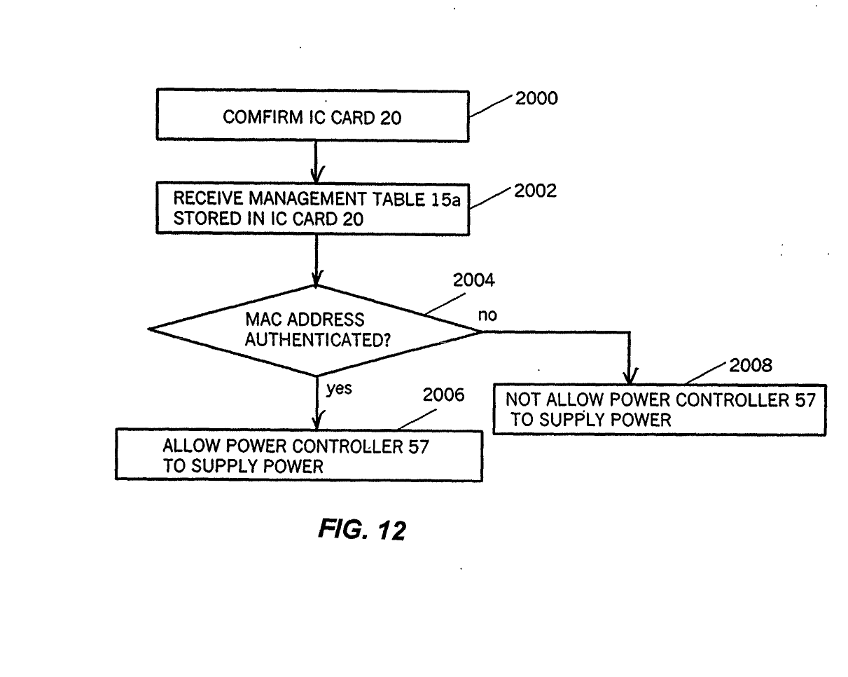

FIG. 12 is a flowchart showing a control operation by the IC card drive 60. The administrator (or a person carrying the IC card 20) should note that a user of the IC card 20 should correspond to a user of the network device 50. The IC card 20 is inserted, after being transported to the network device 50, into the IC card drive 60. When the IC card 20 is inserted into the insertion opening (not shown) in the IC card drive 60, the sensor's output signal becomes OFF. The controller 61 detects the off state, and confirms the presence of the IC card 20 in a step 2000. The controller 61 obtains the management table 15a stored in the IC card 20 through the recorder/reproducer 67 in a step 2002. In a step 2004, the controller 61 determines whether the MAC address in the management table 15a corresponds to the MAC address of the network device 50 that has been stored in the storage part 65.

In this case, the IC card 20 does not store the MAC address. Accordingly, the controller 61 is programmed to authenticate the IC card 20 to perform the initial setup operation when it finds no MAC address in the management table 15a being stored in the IC card 20. Even when the controller 61 uses network information other than the MAC address, such as the IP address or the VLAN in step 2004, such information is not stored in the storage part 65 at this stage. Accordingly, the controller 61 authenticates the IC card 20 to perform the initial setup operation when the management table 15a lacks part of the network information.

The controller 61 sends, when confirming the correspondence, a signal that allows the power controller 57 to supply power through the signal transmitter 66 in a step 2006. Thereby, the power is available to the network device 50 in addition to the IC card drive 60, and the entire network device 50 becomes usable. As discussed above, when the IC card 20 stores no MAC address, the controller 61 preferably allows the network device 50 to record the communication parameters, which will be described later, and to store information into the IC card 20. Likewise, when the storage part 65 lacks part of the other network information, the controller 61 preferably allows the network device 50 to record the communication parameters and to store information into the IC card 20. Thus, this configuration operation maintains the security against unauthorized users who attempt to access the network device 50.

If the controller 61 does not confirm the correspondence except during the initial configuration time, the power is not supplied to the network device 50 except the IC card drive 60 in a step 2008. The controller 61 may electrically control the eject button (not shown) to perform the above ejection step. Thereby, the administrator (or user) recognizes that the inserted IC card is a card that does not correspond to the network device 50 (or is an unusable card).

The authentication of the MAC address after the insertion of the IC card 20 is executed in the general use of the network device 50. Thus, users who try to use an unauthorized IC card or have no IC card are prevented from using the network device 50, and the security may be enhanced in the network device 50.

In step 1100, in accordance with the initial configuration program stored in the storage part 55, the controller 51 reads and sets part of the communication parameters stored in the IC card 20, which has been inserted into the IC card drive 60, where the communication parameter corresponds to the present network device 50. More specifically, the controller 51 sets up in the storage part 55 the communication parameters that have been obtained through the IC card drive 60 and the interface 56. Since the controller 51 automatically sets up the communication parameter, a setup of the communication parameter is easier than the manual setup using the serial communications. Although this embodiment stores the communication parameters stored in the IC card 20, into the storage part 55, the controller 51 may stores the communication parameters that have been obtained through the interface 56, into the RAM 53. In this case, the network device 50 is given the communication parameters when the IC card 20 is inserted into the IC card drive 60, and a user who has no IC card 20 cannot use the network device 50.

Referring back to FIG. 9, after the communication parameters have been set up, the controller 51 stores in the IC card 20 device information unique to the network device 50 in a step 1200. The step 1200 is indicated as an arrow from the network device 50 to the IC card 20 in FIG. 11.

More specifically, the controller 51 commands the IC card drive 60 via the interface 56 to transmit the device information from the storage part 55 and store it in the IC card 20. If the user ID and password pair has not yet been included in the management table 15a, the controller 51 stores this data together with the device information in the IC card 50 at this time. Similarly, the controller 51 uses the interface 56 to store in the storage part 65 in the IC card drive 60 part or all of the network information necessary for authentication that makes the network 50 available. Alternatively, the controller 51 communicates with the IC card drive 60, and the controller 61 directly reads from the IC card 20 part or all of the network information necessary for authentication, and stores it in the storage part 65. Data in the IC card 20 may be stored in the storage part before the communication parameters are set up in the network device 50.

The user then transports the IC card 20 to the management device 10, and inserts it into the IC card drive 17. As described above, the user of the network device 50 does not have to transport the IC card 20 to the management device 10 personally, but may send it by mail or with another person. The controller 11 then commands the IC card drive 17 via the interface 16 to transmit the device information from the IC card 20, and adds the received device information to the management table 15a in the storage part 15 in a step 1300. The step 1300 is indicated as an arrow from the IC card 20 to the management device 10 in FIG. 11.

The controller 11 records a “collected” status in the management table 15a so as to indicate that the device information has been collected and stored, and in the IC card 20 as well. The controller 11 may set up the interconnecting device 40 so that a different VLAN is assigned to each or some of the network devices 50, based on the MAC address stored in the management table 15a. The administrator previously performed this VLAN configuration upon request from the user of the network device 50, or the administrator may be prompted to set up the VLAN when the MAC address is stored.

A description of the management operation of the network 100 by the management system 1 will now be discussed. The above steps assign communication parameters to the network device(s) 50. Alternatively, the IC card 20 is inserted into the IC card drive 60 and the network device 50 is assigned communication parameters. The controller 31 in the entrance server 30 receives a notice from the interconnecting device 40 through the communication port 32 that the network device 50 connected to the interconnecting device 40 is turned on. In response to this notice, the controller 31 receives from the interconnecting device 40 the MAC address of the network device 50 connected to the interconnecting device 40. The controller 31 then requests the management device 10 to transmit the management table 15a or to confirm whether the received MAC address is stored in the management table 15a.

The controller 31 stores, when receiving the management table 15a, the management table 15a in the storage part 35. The controller 31 refers to the management table 15a in the storage part 35, and determines whether the received MAC address has been stored. When the controller 31 requests the confirmation, the controller 31 receives the authentication result from the management device 10.

When the received MAC address is stored in the management table 15a, the controller 31 allows the interconnecting device 40 to communicate using its interconnecting port 42. Thereby, the network device 50 communicates with the common server 70 and other network devices 50 in the same VLAN. As described above, the management device 10 manages structure, performance, security, and billing of the network 100 by managing the connection and traffic statuses through the interconnecting device 40.

When the received MAC address is not stored in the management table 15a, it prohibits the communication through the interconnecting port 42 in the interconnecting device 40, to which the network device 50 that has the received MAC address is connected. The controller 31 may notify the administrator of the management device 10 of the unauthorized access to the network 100 through the network device 50.

The entrance server 30, using such a step, permits the network device 50 having the predetermined MAC address to access the network 100, prohibiting the unauthorized network devices from accessing the network 100.

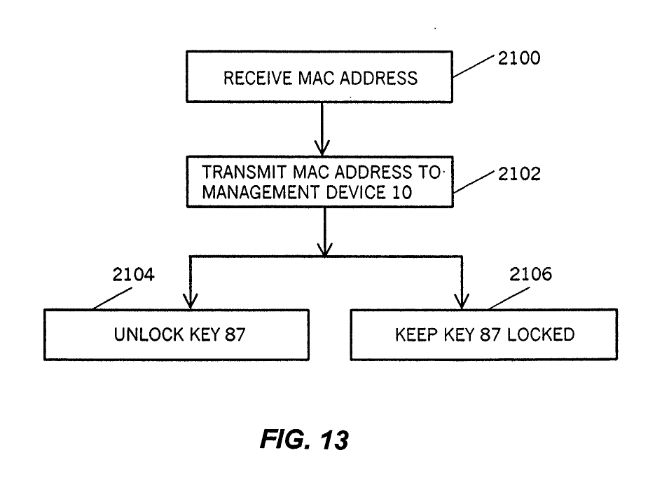

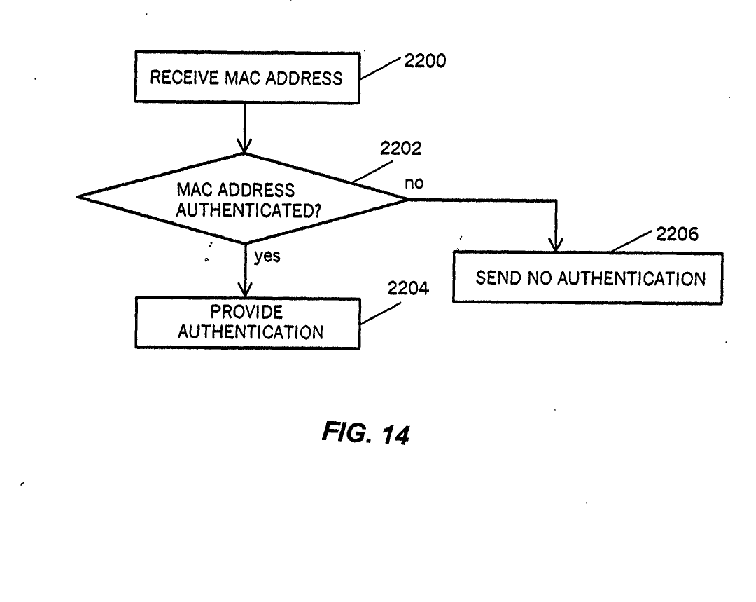

A description will now be given of the management operation of the office 200 in the management system 1, with reference to FIGS. 13 and 14. Here, FIG. 13 is a flowchart of one embodiment of a control method of the admittance manager 80. FIG. 14 is a flowchart of one embodiment of the control method of the management device 10.

A user who enters the office 200 receives the IC card 20 from the administrator. The above initial configuration stores the MAC address and communication parameters in the IC card 20, corresponding to the network device 50 which the user attempts to use. The user who enters the office 200 uses the IC card 20 as a unique key to lock and unlock the key 87 at the entrance of the office 200 in this embodiment.

When the user enters the office 200, he/she inserts the IC card 20 into the IC card reader 86 in the admittance manager 80. Then, as shown in FIG. 13, the controller 81 in the admittance manager 80 receives the MAC address stored in the IC card 20 in a step 2100. The controller 81 then sends the received MAC address to the management device 10 through the transmitter/receiver 85 in a step 2102, and awaits a response from the controller 10.

Referring to FIG. 14, the communication port 12 receives the MAC address sent in the step 2102, and transfers the address to the controller 11 in the management device 10 in a step 2200. The controller 11 checks if the MAC address exists in the management table 15a step 2202.

When the controller 11 does not provide an authentication in the step 2202 (for example, because the user inserts the IC card 20 into the IC card reader 86 of a different room or uses an IC card for different purposes, because a person seeking an unauthorized access uses a fake IC card, or the like), the controller 11 informs the admittance manager 80 through the communication port 12 that it cannot authenticate the information in a step 2206.

When the MAC address can be authenticated in step 2202, the controller 11 informs the admittance manager 80 that the MAC address has been authenticated in a step 2204.

Referring back to FIG. 13, in response to the predetermined notice from the management device 10, the controller 81 executes a predetermined process based on the received information through the transmitter/receiver 85. More specifically, when the controller 81 receives the notice that the MAC address is not authenticated, the controller 81, for instance, indicates a message “IC card not authenticated” on the display (not shown), and does not unlock the key 87 in a step 2106. The user, when seeing such a message, can repeat the similar procedure using the proper IC card. The user, who sees the message though he has used the proper IC card, can contact the administrator for help. An unauthorized person will typically give up entering the room since the key 87 is kept unlocked.

The controller 81 unlocks the key 87 when receiving a notice that the MAC address has been authenticated in a step 2104. After the step 2104, the controller 81 may indicate a message “proceed” on the display (not shown).

The user who has entered the office 200 may work using the network device 50. As described above, only the user having such an IC card 20 as stores the MAC address of the network device 50 i.e., the authorized user of the network device 50 may power on the network device 50. As a result, an unauthorized use of the network device 50 may be prevented. In addition, the network has created the high security circumstance as described above, and the security circumstance prevents an unauthorized person from modifying and obtaining files.

As discussed above, according to the management system 1 of the present invention, the management device 10 performs a unitary management of the network management for each network device 50 and admittance to the office 200. In addition, the management system 1 may assign different VLANs for respective network devices 50 based on their MAC addresses, maintaining the high level of security for the network 100. The IC card 20 can perform the initial configuration for the network devices 50, improving the security in comparison with the conventional method. The network device 50 is not usable without the IC card 20 storing its MAC address. Thereby, the network device 50 is protected from unauthorized users.

Further, the present invention is not limited to the preferred embodiment, and various variations and modifications may be made without departing from the present invention. The management system of the present invention is applicable, for example, to an apartment, house, school, etc. Although the above embodiment manages only one room, the management device may manage admittance to a number of rooms and a number of network devices.

The management method and system of the present invention can control the power supply to a network device using the IC card storing the MAC address of the network device, preventing a person who has no IC card from using the network. In addition, the management device for managing the network devices performs a unitary management for the network and access to each network (for example, in an office or a school). Therefore, this management system enhances the added and asset value of the office, apartment, house, or school.

What is claimed is:

1. A management system comprising:
a first device, connected to a network and assigned network information that allows said first device to communicate over the network;
a management device, connected to the network, which manages said first device based on said network information, and stores the network information in an information recordable medium; and
a drive unit, configured to read the information recordable medium, wherein said first device is made accessible to a user when the network information for said first device read from said information recordable medium by said drive unit corresponds to said network information assigned to said first device.

2. The management system of claim 1, wherein said information recordable medium is an integrated circuit card.

3. The management system of claim 1, wherein said drive unit further comprises:
a storage part for storing said network information of said first device; and
a controller, configured to store said network information read from said information recordable medium in said storage part upon determining that said network information has not yet been stored in said storage part.

4. The management system of claim 1, wherein said drive unit further comprises:
a storage part for storing said network information of said first device; and
a controller configured to compare data read from the information recordable medium with said network information stored in said storage part, and to make said first device accessible to a user upon determining that said data read from the information recordable medium corresponds to said network information stored in said storage part.

5. The management system of claim 1, wherein said drive unit communicates with said management device, and wherein said management device further comprises:
a storage part for storing said network information of said first device; and
a controller, configured to compare data sent from said drive unit with said network information stored in said storage part, and to make said first device accessible to a user upon determining that said data corresponds to said network information stored in said storage part.

6. The management system of claim 1, further comprising an interconnecting device which connects the network to said first device and said management device, wherein said management device configures said interconnecting device so as to assign a virtual local area network (VLAN) to said first device based on said network information assigned to said first device.

7. The management system of claim 6, wherein said network information includes a VLAN.

8. The management system of claim 1, further comprising an interconnecting device which connects the network to said first device and said management device, and executes a predetermined operation when said drive unit reads predetermined data from said information recordable medium.

9. The management system of claim 1, further comprising an admittance manager, connected to said management device, which controls admittance into an area in which the network is built, by reading said information recordable medium and communicating with said management device

10. The management system of claim 9, wherein the network includes a plurality of virtual local area networks (VLANs), and wherein one of said VLANs is assigned to the area in which the network is built.

11. The management system of claim 1, wherein said network information includes a communication parameter necessary for said first device to communicate over the network, and device information that defines said first device.

12. The management system of claim 1, wherein said network information is a MAC address of said first device.

13. An access management system comprising:
a first device, connected to a network and assigned network information that allows the first device to communicate on the network, comprising a first drive unit for reading network information from an information recordable medium; and
a second device, connected to the network, which manages said first device based on the network information, wherein said second device comprises a second drive unit for storing network information into the information recordable medium, and wherein said first device is made accessible to a user when the network information read by said first drive unit from said information recordable medium corresponds to the network information assigned to said first device.

14. A method of managing access to a network through a managed device, wherein the managed device is connected to the network and assigned network information which allows the managed device to communicate over the network, said method comprising:
reading data from an information recordable medium;
storing the network information in a storage part;
determining whether data read from the information recordable medium corresponds to the network information stored in the storage part; and
making the managed device accessible in the network when said data read from the information recordable medium is determined to correspond to the network information stored in the storage part.

15. The method of claim 14, further comprising configuring the network information in the managed device with data read from the information recordable medium.

16. A network device connected to a network and assigned network information that allows the network device to communicate over the network, the network device including a drive unit, said drive unit comprising:
a reader part for reading data from an information recordable medium;
a storage part that stores the network information; and
a controller that makes the network device accessible upon determining that data read by said reader part from the information recordable medium corresponds to the network information stored in said storage part.

17. The network device of claim 16, wherein said controller sets up the network information read by said reader part from the information recordable medium, when determining that the network information has not yet been stored in said storage part.

18. The network device of claim 16, wherein said drive unit controls power to be supplied to said network device, and said controller makes the network device accessible by allowing the power to be supplied to said network device.

19. A management device, connected to a network, which manages a first device connected to the network, and assigned network information that allows said management device to communicate over the network, said management device comprising:
a storage part which stores the network information;
a drive unit which stores the network information into an information recordable medium to be used to configure said first device; and
a controller which controls access to the network device.

20. A computer readable medium having a program for executing a method of making accessible a managed device that is connected to a network and assigned network information that allows said managed device to communicate over the network, the network information being stored in an information recordable medium and a storage part, said method comprising:
determining whether data read from the information recordable medium corresponds to the network information that has been stored in a storage part; and
making the managed device accessible in the network when said determining determines that the data read from the information recordable medium corresponds to the network information stored in the storage part.

21. The computer readable medium of claim 20, wherein said method further comprises:
determining whether the network information is stored in the storage part; and
allowing the storage part to store the network information when said determining determines that the network information has not yet been stored in the storage part.

22. A system for managing access to a network through a managed device, wherein the managed device is connected to the network and assigned network information which allows the managed device to communicate over the network, said system comprising:
means for reading data from an information recordable medium;
means for storing the network information in a storage part;
means for determining whether data read from the information recordable medium corresponds to the network information stored in the storage part; and
means for making the managed device accessible in the network when said data read from the information recordable medium is determined to correspond to the network information stored in the storage part.

23. The system of claim 22, further comprising means for setting up the network information in the managed device with data read from the information recordable medium.
